(19) United States
(12) Patent Application Publication
(10) Pub. No.: US 2012/0221380 A1
(43) Pub. Date: Aug. 30, 2012

(54) Teller Readiness Simulation

(75) Inventors: Dia G. Dissmore, Bothell, WA (US); David Bonello, Farmington Hills, MI (US); Richard Hense, Tampa, FL (US); Alicja Zopf, Tinley Park, IL (US); Stephanie R. Foster, Orlando, FL (US); Michael A. Gardner, Indian Trail, NC (US)

(73) Assignee: Bank of America Corporation, Charlotte, NC (US)

(21) Appl. No.: 13/036,804

(22) Filed: Feb. 28, 2011

(51) Int. Cl. G06Q 10/00

(52) U.S. Cl. 705/7.42

(57) ABSTRACT

In some embodiments, a teller readiness system comprises a teller simulator and a scoring engine. The teller simulator is operable to present a banking scenario to a user. The banking scenario simulates a transaction between a bank customer and the user. The teller simulator identifies tasked to be completed by the user and receives actions performed by the user in response to the scenario. The scoring engine is operable to determine a task score for each task based on the actions performed by the user. Each task is associated with one of a plurality of skills. Each skill of the plurality of skills represents a facet of teller readiness. The scoring engine assigns a weight to each of the task scores to yield weighted task scores. The scoring engine determines a skill score for one of the skills based on the weighted task scores associated with the one of the skills.

### TECHNICAL FIELD

The present disclosure relates to simulations generally and more specifically to teller readiness simulations.

### BACKGROUND

A teller is an employee of a financial institution who deals directly with customers. When interacting with the customer, the teller may facilitate the customer's financial activities, which may include, but are not limited to, banking activities, extending credit to account holders, and supervising a customer's portfolio. Before interfacing with customers and handling these financial activities, the teller may be trained.

### SUMMARY

In some embodiments, a teller readiness system comprises a teller simulator and a scoring engine. The teller simulator is operable to present a banking scenario to a user. The banking scenario simulates a transaction between a bank customer and the user. The teller simulator identifies tasks to be completed by the user and receives actions performed by the user in response to the scenario. The scoring engine is operable to determine a task score for each task based on the actions performed by the user. Each task is associated with one of a plurality of skills. Each skill of the plurality of skills represents a facet of teller readiness. The scoring engine assigns a weight to each of the task scores to yield weighted task scores. The scoring engine determines a skill score for one of the skills based on the weighted task scores associated with the one of the skills.

Certain embodiments may provide one or more technical advantages. A technical advantage of one embodiment may include the capability to train new tellers through a teller simulation. A technical advantage of one embodiment may also include the capability to simulate both customer interactions and use of banking equipment. A technical advantage of one embodiment may also include the capability to score a new teller's skills as they relate to the teller position. The scoring may be used to determine whether a teller is ready to handle actual customer transactions.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its advantages, reference is now made to the following description taken in conjunction with the accompanying drawings, in which:

FIG. 1 shows a teller assessment system according to one embodiment;

FIGS. 2A-2G show example screen shots from a teller simulator according to one embodiment; and

FIG. 3 shows a method for assessing teller readiness according to one embodiment.

### DETAILED DESCRIPTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

A teller is an employee of a financial institution who deals directly with customers. A financial institution may include any individual, business, or organization that engages in financial activities, which may include, but are not limited to, banking and investment activities such as maintaining accounts (e.g., transaction accounts, savings accounts, credit accounts, investment accounts, insurance accounts, portfolios, etc.), receiving deposits, crediting accounts, debiting accounts, extending credit to account holders, purchasing securities, providing insurance, and supervising a customer's portfolio.

A teller may be the first person that a customer interacts with at a financial institution. The teller may assist the customer in performing various transactions. Examples of transactions may include depositing, withdrawing, issuing negotiable items (cashier's checks, traveler's checks, money orders, federal draft issuances, etc.), collecting payments, promoting the financial institution's products (loans, mortgages, credit cards, trusts, insurance, etc.), advancing cash, purchasing bonds, resolving customer issues, and ordering products for the customer (checks, deposit slips, etc.).

Thus, the teller position may require customer service skills as well as an understanding of how the financial institution processes transactions. Accordingly, teachings of certain embodiments recognize the capability to train new tellers through a teller simulation. Teachings of certain embodiments also recognize the capability to simulate both customer interactions and use of banking equipment. Teachings of certain embodiments also recognize the capability to score a new teller's skills as they relate to the teller position. The scoring may be used to determine whether a teller is ready to handle actual customer transactions.

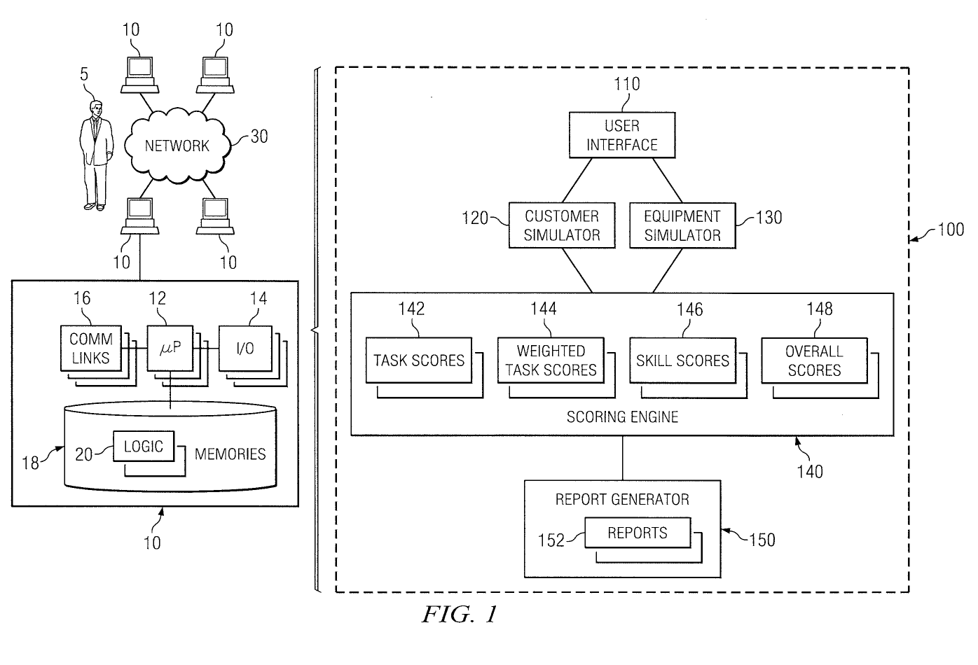

FIG. 1 shows a teller assessment system 100 according to one embodiment. In general, system 100 presents a teller readiness simulation to user 5 and scores the performance of user 5. The example teller assessment system 100 of FIG. 1 features user interface 110, customer simulator 120, equipment simulator 130, scoring engine 140, and report generator 150, that may be implemented by one or more computer systems 10.

Users 5 may access teller assessment system 100 through computer systems 10. For example, in some embodiments, users 5 interact with user interface 110, customer simulator 120, and/or equipment simulator 130 through computer systems 10.

Users 5 may include any individual, group of individuals, entity, machine, and/or mechanism that interacts with computer systems 10. Examples of users 5 include, but are not limited to, a teller, a manager, executive, review board, accountant, engineer, technician, contractor, agent, and/or employee. Users 5 may be associated with an organization. An organization may include any social arrangement that pursues collective goals. One example of an organization is a business. A business is an organization designed to provide goods or services, or both, to consumers, governmental entities, and/or other businesses. Examples of a business may include, but are not limited to, financial institutions, agriculture and mining businesses, manufacturers, real estate companies, retailers and distributors, service businesses, transportation companies, and utility companies. A business may include both for-profit and not-for-profit businesses. An organization may also include multiple businesses. For example, an organization may control businesses in multiple jurisdictions throughout the world. Examples of organizations are not limited to businesses. For example, an organization can itself be a government entity. In one example embodiment, teller assessment system 100 is associated with a financial institution, and user 5 is an employee or representative of the financial institution, such as a teller.

Computer system 10 may include processors 12, input/output devices 14, communications links 16, and memory 18. In other embodiments, computer system 10 may include more, less, or other components. Computer system 10 may be operable to perform one or more operations of various embodiments. Although the embodiment shown provides one example of computer system 10 that may be used with other embodiments, such other embodiments may utilize computers other than computer system 10. Additionally, embodiments may also employ multiple computer systems 10 or other computers networked together in one or more public and/or private computer networks, such as one or more networks 30.

Processors 12 represent devices operable to execute logic contained within a medium. Examples of processor 12 include one or more microprocessors, one or more applications, and/or other logic. Computer system 10 may include one or multiple processors 12.

Input/output devices 14 may include any device or interface operable to enable communication between computer system 10 and external components, including communication with a user or another system. Example input/output devices 14 may include, but are not limited to, a mouse, keyboard, display, and printer.

Network interfaces 16 are operable to facilitate communication between computer system 10 and another element of a network, such as other computer systems 10. Network interfaces 16 may connect to any number and combination of wireline and/or wireless networks suitable for data transmission, including transmission of communications. Network interfaces 16 may, for example, communicate audio and/or video signals, messages, internet protocol packets, frame relay frames, asynchronous transfer mode cells, and/or other suitable data between network addresses. Network interfaces 16 connect to a computer network or a variety of other communicative platforms including, but not limited to, a public switched telephone network (PSTN); a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable network interfaces; or any combination of the preceding.

Memory 18 represents any suitable storage mechanism and may store any data for use by computer system 10. Memory 18 may comprise one or more tangible, computer-readable, and/or computer-executable storage medium. Examples of memory 18 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

In some embodiments, memory 18 stores logic 20. Logic 20 facilitates operation of computer system 10. Logic 20 may include hardware, software, and/or other logic. Logic 20 may be encoded in one or more tangible, non-transitory media and may perform operations when executed by a computer. Logic 20 may include a computer program, software, computer executable instructions, and/or instructions capable of being executed by computer system 10. Example logic 20 may include any of the well-known OS2, UNIX, Mac-OS, Linux, and Windows Operating Systems or other operating systems. In particular embodiments, the operations of the embodiments may be performed by one or more computer readable media storing, embodied with, and/or encoded with a computer program and/or having a stored and/or an encoded computer program. Logic 20 may also be embedded within any other suitable medium without departing from the scope of the invention.

Various communications between computers 10 or components of computers 10 may occur across a network, such as network 30. Network 30 may represent any number and combination of wireline and/or wireless networks suitable for data transmission. Network 30 may, for example, communicate internet protocol packets, frame relay frames, asynchronous transfer mode cells, and/or other suitable data between network addresses. Network 30 may include a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable communication links; or any combination of the preceding. Although the illustrated embodiment shows one network 30, teachings of certain embodiments recognize that more or fewer networks may be used and that not all elements may communicate via a network. Teachings of certain embodiments also recognize that communications over a network is one example of a mechanism for communicating between parties, and any suitable mechanism may be used.

User interface 110 may include any component operable to facilitate interaction between user 5 and customer simulator 120 and/or equipment simulator 130. For example, user interface 110 may include graphical, textual, and auditory information that the customer simulator 120 and/or equipment simulator 130 presents to user 5. User interface 110 may also receive control sequences (such as keystrokes with the computer keyboard, movements of the computer mouse, or selections with a computer touchscreen) that user 5 employs to interact with customer simulator 120 and/or equipment simulator 130. In some embodiments, user interface 110 may incorporate a graphical user interface (GUI), such as a web-based user interface.

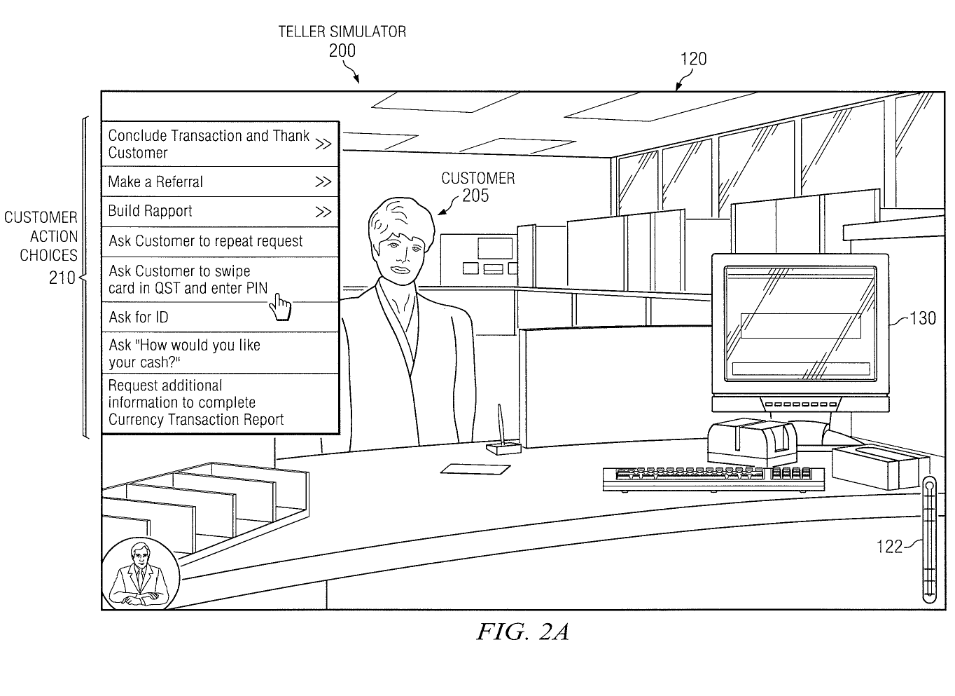

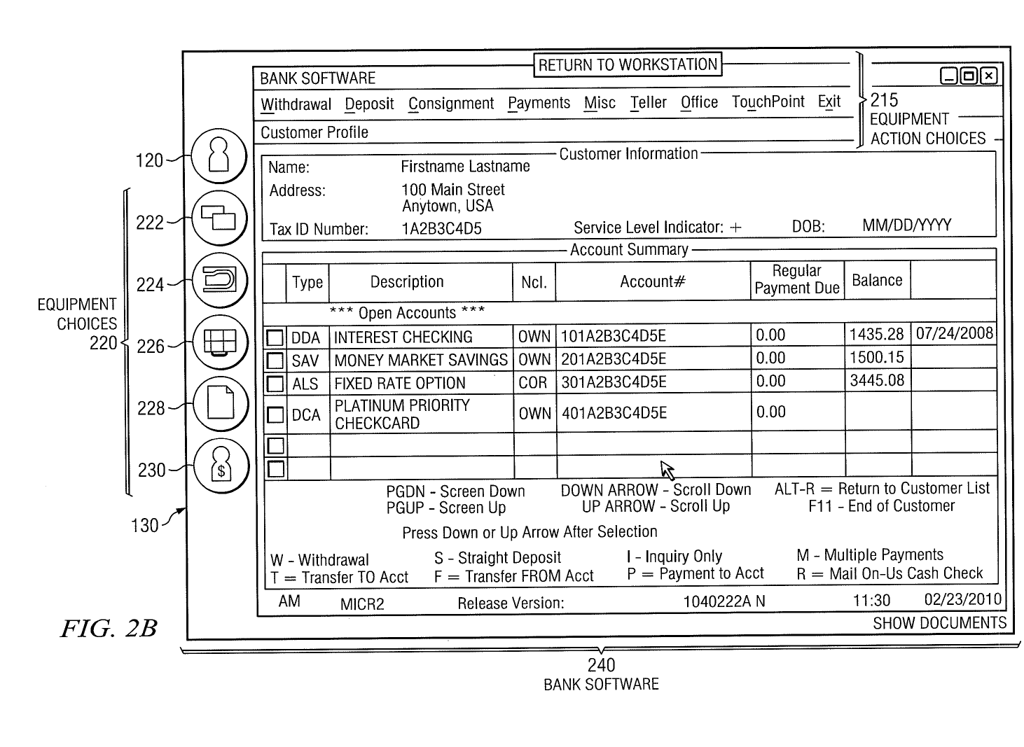

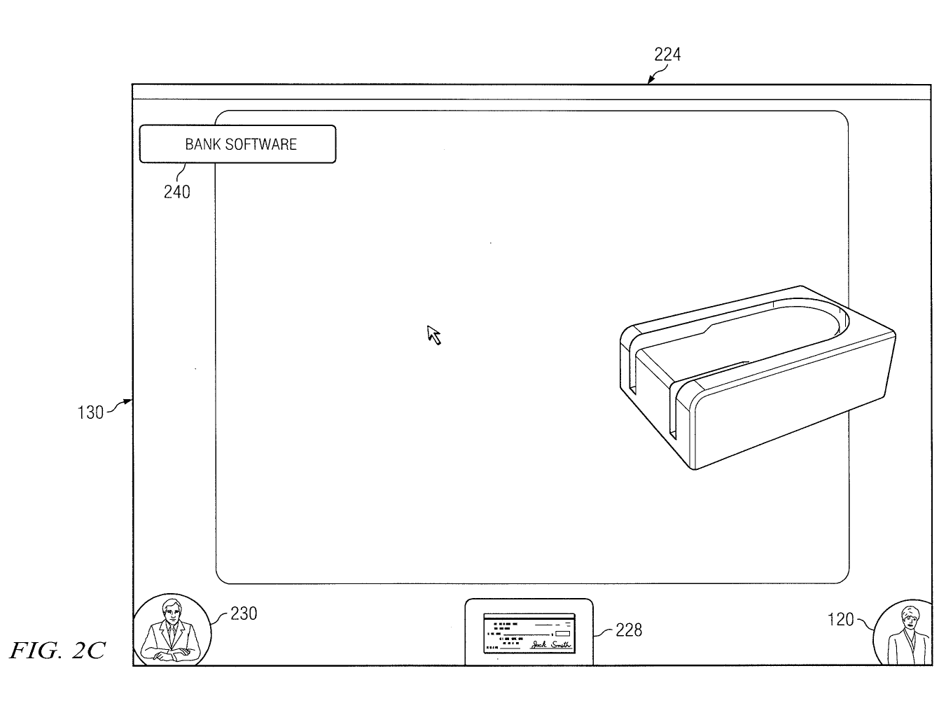

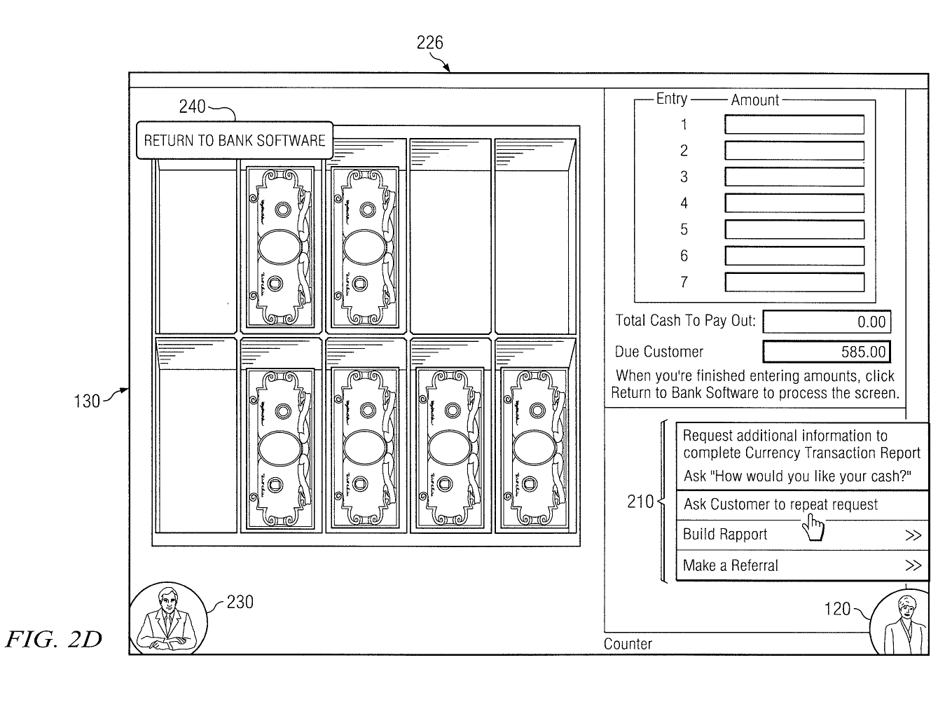

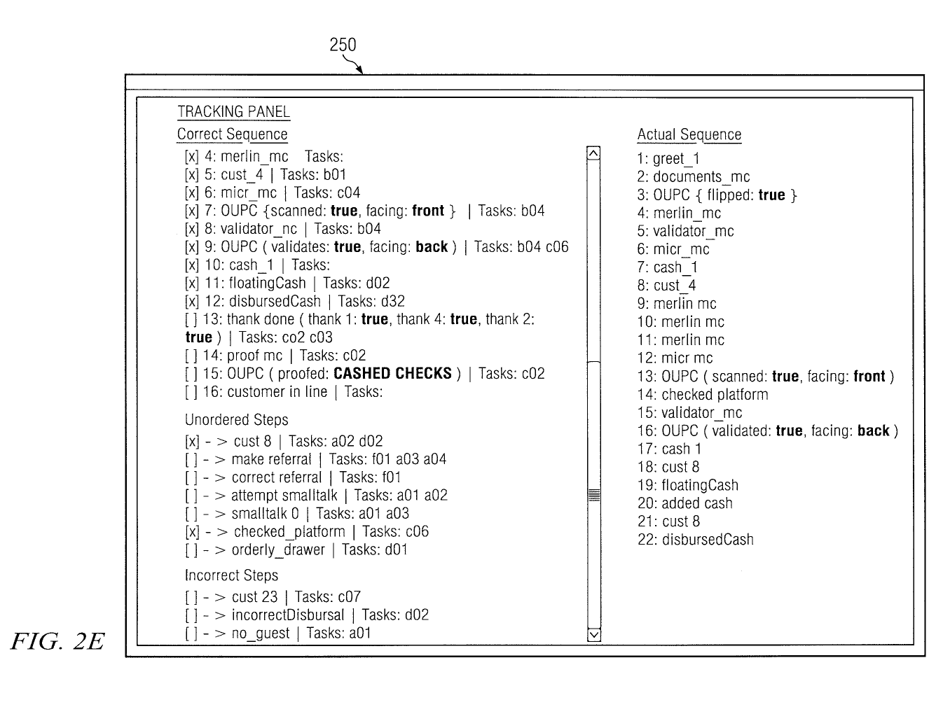

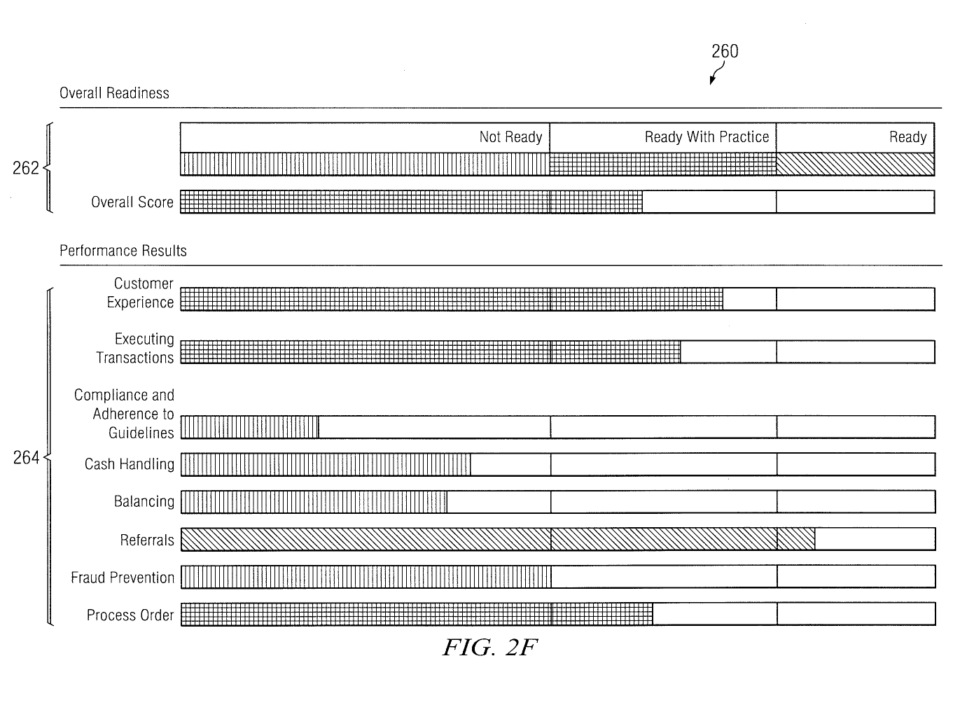

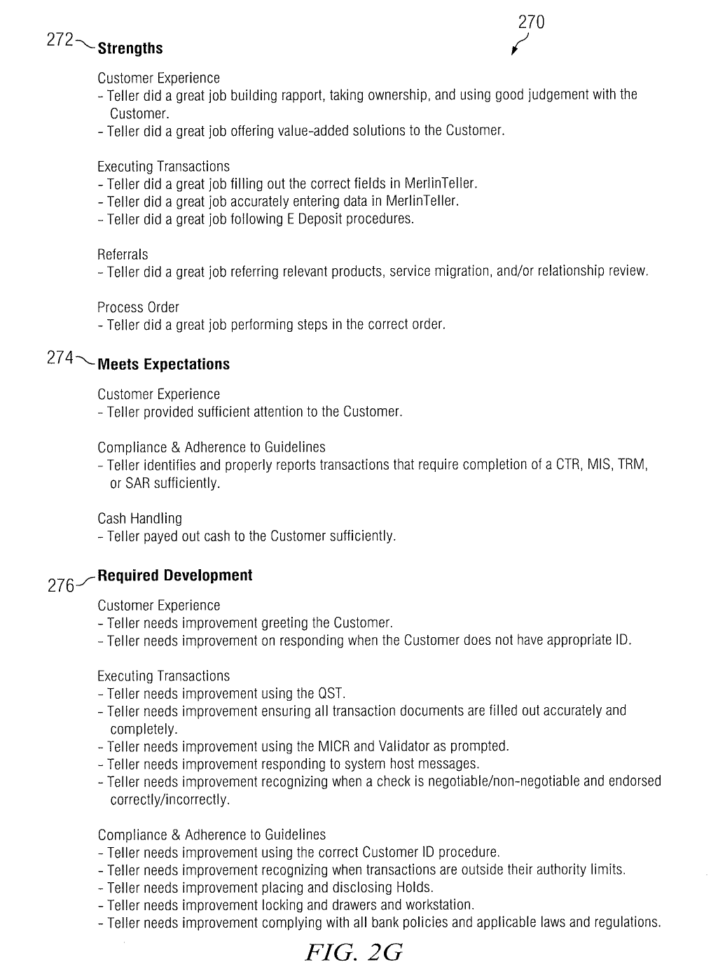

Customer simulator 120 represents a component that simulates an interaction between user 5 and a customer. For example, customer simulator 120 may simulate how a teller welcomes the customer to the financial institution. Teachings of certain embodiments recognize that customer simulator 120 may simulate the interaction between user 5 and the customer based on inputs received from user 5 through user interface 110. For example, in one embodiment, customer simulator 120 does not welcome the customer to the financial institution until after receiving instructions from user 5. Example instructions may include a keystroke or mouse click instructing customer simulator 120 on when and/or how to greet the customer. An example of customer simulator 120 is described in greater detail with regard to FIG. 2A.

Equipment simulator 130 represents a component that simulates an interaction between user 5 and one or more pieces of banking equipment. Examples of banking equipment may include, but are not limited to, a computer running banking software, a validator, a magnetic ink character recognition (MICR) reader, and a cash drawer. Furthermore, equipment simulator 130 is not limited to simulating inanimate objects, tools, or devices. For example, equipment may also include places or people. As one example, equipment simulator 130 may simulate the teller window or counter, including the items placed on the counter during interaction with the customer (such as cash, credit cards, deposit slips, etc.). As another example, equipment simulator 130 may simulate a supervisor. For example, if user 5 identifies fraud or determines that supervisor approval is required, equipment simulator 130 may simulate an interaction between user 5 and a supervisor. Examples of equipment simulator 130 is described in greater detail with regard to FIGS. 2B-2D.

Scoring engine 140 represents a component that tracks and scores the actions of user 5. In one example embodiment, scoring engine 140 determines task scores 142, weighted task scores 144, skill scores 146, and overall scores 148.

Task scores 142 measure the performance of user 5 on particular tasks. In some embodiments, task scores 142 are numerical scores, although teachings of certain embodiments recognize that task scores 142 may be represented in any suitable format. For example, in one embodiment, scoring engine 140 may express task scores 142 as either complete or incomplete.

In one example, scoring engine 140 may score whether user 5 attempts to build rapport with the customer. For example, user 5 may build rapport with the customer by selecting one of the “build rapport” options in the customer simulator 120. If user 5 does build rapport with the customer, task scores 142 may include a completion score or a graded score for the building-rapport task.

Teachings of certain embodiments recognize that there may not be a one-to-one correlation between actions of user 5 and tasks. For example, in some embodiments, certain actions taken by user 5 are not scored. In other embodiments, an action by user 5 may correspond to multiple tasks. An example listing of tasks and actions is described below with regard to FIG. 2E.

In one embodiment, task scores 142 represent a score based on the order in which user 5 performs tasks. As one example, user 5 may lose points by returning cash to the customer before receiving the customer's signature for the transaction. Teachings of certain embodiments recognize that adhering to a process is a significant component to being an effective teller. Adding steps may add time and lead to unintended consequences, and missing steps or performing them out of order can lead to errors or missing potential fraudulent activities.

Weighted task scores 144 are weighted versions of task scores 142. Teachings of certain embodiments recognize that certain tasks may be more important for teller performance or may be more accurate in representing real-world teller tasks. For example, greeting a customer may be more important than building rapport with the customer. As another example, scoring engine 140 may assign a lower weight to certain rapport tasks because customer simulator 120 may not be able to accurately predict real-life customer behavior in all circumstances. Thus, teachings of certain embodiments recognize that scoring engine 140 may adjust weights to account for the limitations of customer simulator 120 and/or equipment simulator 130. In some embodiments, weighed task scores 144 are numerical scores, although teachings of certain embodiments recognize that weighed task scores 144 may be represented in any suitable format.

Skill scores 146 represent scores based on assessing various facets of teller readiness. Example skills may include, but are not limited to, providing a quality customer experience, executing transactions, complying and adhering to guidelines, handling cash, balancing, referring customers to other business opportunities, preventing potential fraud, and performing steps in the correct order. The customer experience skill assesses how well a teller interacts with a customer, such as how well the teller builds rapport with the customer. The executing transactions skill assesses how well the teller completes transactions, such as receiving deposits and making withdrawals. The balancing skill refers to the teller's ability to consistently balance the ledgers, cash drawer, and other items. The referrals skill assesses the teller's ability to refer the customer to other products and services offered by the financial institution, such as investment services, mortgages, and insurance. Fraud prevention refers to the teller's ability to detect potential fraud during a customer interaction. The process order skill is the teller's ability to perform steps in the correct order.

In one example embodiment, each task reflects one skill such that each weighed task score 144 contributes to one skill score 146. For example, in one embodiment, scoring engine 140 computes each skill score 146 by adding all of the weighed task scores 144 for each skill. In some embodiments, skill score 146 shares the same scale and/or maximum score. For example, in one embodiment, each skill score 146 has a maximum score of 100, and scoring engine 140 defines the weighed task scores 144 such that the sum of all weighed task scores 144 for each skill equals 100. Thus, teachings of certain embodiments recognize the capability to apply weights to task scores 142 such that the weighed task scores 144 satisfy various scaling metrics.

As one example, the customer experience skill may have six basic tasks: (1) perform one of the following: build rapport, take ownership, use good judgment, escalate issues; (2) perform one of the following: clarify a customer's request, empathize and listen, use a warm tone, show enthusiasm, use positive and delightful language; (3) offer a value-added solution; (4) respond appropriately when the customer does not have appropriate identification; (5) perform one of the following: smile, greet, be respectful, make eye contact, use customer's name, be courteous; and (6) thank the customer. In this example, the task scores 142 may be represented by either a “complete” or an “incomplete.” Scoring engine 140 may represent a completed task by 1 and an incomplete task by 0. Scoring engine 140 may also apply the following weights to task scores 142 to yield weighted task scores 144: 18, 18, 15, 18, 15, and 16. In this example, the sum of the weighed tasked scores 144 equals 100 such that the maximum skill score 146 for customer experience is 100.

As another example, the executing transactions skill may have eight tasks: (1) accurately input data; (2) correctly identify the type of transaction by using correct speed key and/or key strokes; (3) correctly respond to system host messages; (4) ensure all transaction documents have been filled out completely and accurately; (5) fill out correct fields; (6) recognize when a check is negotiable/non-negotiable and endorsed correctly/incorrectly; (7) use MICR/validator as prompted; (8) use cash drawer (as appropriate). In this example, the task scores 142 may be represented by either a “complete” or an “incomplete.” Scoring engine 140 may represent a completed task by 1 and an incomplete task by 0. Scoring engine 140 may also apply the following weights to task scores 142 to yield weighted task scores 144: 14.75, 10, 11, 14.75, 13.75, 14.75, 10, 11. In this example, the sum of the weighed tasked scores 144 equals 100 such that the maximum skill score 146 for executing transactions is 100.

As yet another example, the compliance skill may have five tasks: (1) comply with all bank policies and applicable laws/requirements; (2) lock drawers and workstation; (3) place and disclose holds appropriately; (4) recognize when transactions are outside authority limits; (5) use correct customer identification procedure. In this example, the task scores 142 may be represented by either a “complete” or an “incomplete.” Scoring engine 140 may represent a completed task by 1 and an incomplete task by 0. Scoring engine 140 may also apply the following weights to task scores 142 to yield weighted task scores 144: 23, 7, 23, 23, 24. In this example, the sum of the weighed tasked scores 144 equals 100 such that the maximum skill score 146 for compliance is 100.

As yet another example, the cash handling skill may have five tasks: (1) adhere to top and total drawer cash limit; (2) correctly perform buy/sell cash; (3) count cash and maintain drawer/coin vault orderly and consistently; (4) pay out cash correctly, using F5 screen appropriately; (5) receive in cash F5 screen appropriately. In this example, the task scores 142 may be represented by either a “complete” or an “incomplete.” Scoring engine 140 may represent a completed task by 1 and an incomplete task by 0. Scoring engine 140 may also apply the following weights to task scores 142 to yield weighted task scores 144: 10, 10, 20, 30, 30. In this example, the sum of the weighed tasked scores 144 equals 100 such that the maximum skill score 146 for cash handling is 100.

As yet another example, the balancing skill may have two tasks: (1) correctly perform end-or-day balancing process; (2) correctly sort proof work. In this example, the task scores 142 may be represented by either a “complete” or an “incomplete.” Scoring engine 140 may represent a completed task by 1 and an incomplete task by 0. Scoring engine 140 may also apply the following weights to task scores 142 to yield weighted task scores 144: 50, 50. In this example, the sum of the weighed tasked scores 144 equals 100 such that the maximum skill score 146 for balancing is 100.

As yet another example, the referrals skill may have only one task: attempt a referral for basic products and/or service migration and/or relationship review. In this example, the skill score 146 for referrals is 100 if the task is completed and 0 if the task is not.

As yet another example, the fraud skill may have only one task: identify potentially fraudulent checks, identification, and currency. In this example, the skill score 146 for fraud is 100 if the task is completed and 0 if the task is not.

As yet another example, the process order skill may have three tasks: (1) perform all necessary steps (no missing steps); (2) perform only necessary steps (no added steps); (3) perform steps in correct order. In this example, the task scores 142 may be represented by either a “complete” or an “incomplete.” Scoring engine 140 may represent a completed task by 1 and an incomplete task by 0. Scoring engine 140 may also apply the following weights to task scores 142 to yield weighted task scores 144: 33, 33, 34. In this example, the sum of the weighed tasked scores 144 equals 100 such that the maximum skill score 146 for the process order skill is 100.

In some embodiments, skill scores 146 are numerical scores, although teachings of certain embodiments recognize that skill scores 146 may be represented in any suitable format. In one example, scoring engine 140 converts skill scores 146 from a numerical score into categorical assessments. In one example embodiment, skill scores 146 are rated as either high (e.g., skill scores 146 greater than 85), medium (e.g., skill scores 146 between 70 and 85), or low (e.g., skill scores 146 lower than 70). In this example, a high rating may indicate that user 5 is now ready to serve actual customers, a medium rating may indicate that user 5 will be ready to serve actual customers with some practice, and a low rating may indicate that user 5 is not ready to serve actual customers.

Overall scores 148 represent an overall assessment for each user 5. In one example embodiment, overall score 148 may be a mathematical combination of the various skill scores 146 for user 5. In another example embodiment, overall score 148 may reflect various categorical assessments of the skill scores 146 of user 5. For example, in one embodiment, overall score 148 is based on the number of high ratings, medium ratings, and low ratings of user 5. In one example embodiment, overall score 148 may be either “ready” or “not ready.”

In some embodiments, overall score 148 also reflects an experience level of user 5. For example, an experienced teller may be expected to have higher scores than a new hire, and the scale of task scores 142, weighed task scores 144, skill scores 146, and/or overall scores 148 may compensate for experience level.

Report generator 150 may represent any combination of hardware, software, and/or logic configured to generate reports 152. Reports 152 describe the performance of user 5. In some embodiments, reports 152 incorporate information from task scores 142, weighed task scores 144, skill scores 146, and/or overall scores 148. In one example embodiment, report 152 includes the overall score 148, ratings based on skill scores 146, and a description of the strengths and weaknesses of user 5 based on certain skills and/or tasks. In one example, report 152 also includes remediation content instructing user 5 to work on certain skills and/or directing user 5 to additional study materials. Example reports 152 are described below with regard to FIGS. 2F and 2G.

In operation, according to one embodiment, user 5 interacts with customer simulator 120 and equipment simulator 130 through user interface 110. In combination, user interface 110, customer simulator 120, and equipment simulator 130 present a banking scenario to user 5. This banking scenario simulates a transaction between user 5 and a bank customer. In response to the banking scenario, user 5 performs a number of actions. Scoring engine 140 determines task scores 142, weighed task scores 144, skill scores 146, and overall scores 148 based on the actions of user 5. Report generator 150 incorporates information from task scores 142, weighed task scores 144, skill scores 146 and/or overall score 148 into a report 152. Teller assessment system 100 delivers report 152 back to user 5 as well as to the superiors or user 5. The supervisors of user 5 may rely on report 152 in determining whether user 5 is ready to serve live customers.

FIGS. 2A-2G show example screen shots from a teller simulator 200 according to one embodiment. FIG. 2A shows teller simulator 200 operating in a customer simulation mode according to one embodiment. In FIG. 2A, customer simulator 120 shows a customer 205 situated in a simulated banking environment. In this example, customer simulator 120 presents user 5 with several customer action choices 210 for interacting with customer 205: conclude transaction and thank customer 205; make a referral; build rapport; ask customer 205 to repeat request; ask customer 205 to slide card and enter PIN; ask for identification; ask “how would you like your cash?”; and request additional information to complete currency transaction report. In other embodiments, customer action choices 210 may include more, fewer, or different options for interacting with customer 205.

In the embodiment shown in FIG. 2A, customer service indicator 212 presents a gauge of user 5's attention to the customer experience. For example, in one embodiment, user 5 may click on customer service indicator 212 to inform teller simulator 200 that user 5 is thinking about customer presentation tasks, such as making eye contact, smiling, and maintaining good posture. In one example embodiment, customer service indicator 212 includes a timer, and user 5 may be alerted if too much time has passed without user 5 thinking about customer presentation tasks. For example, in the illustrated embodiment, customer service indicator 212 is shown as a thermostat, and the “temperature” may change based on the time elapsed since the last time user 5 thought about customer presentation tasks. In some embodiments, customer service indicator 212 does not include any reminders or prompts; in other embodiments, customer service indicator 212 may remind user 5 to concentrate on customer presentation.

In the embodiment shown in FIG. 2A, the simulated banking environment includes banking equipment. Teachings of certain embodiments recognize that user 5 may access equipment simulator 130 from customer simulator 120. For example, in one embodiment, user 5 may access equipment simulator 130 by clicking on the banking equipment in customer simulator 120. Teachings of certain embodiments also recognize the capability for customer simulator 120 and equipment simulator 130 to exchange and share information within teller simulator 200.

FIG. 2B shows teller simulator 200 operating in an equipment simulation mode according to one embodiment. In FIG. 2B, equipment simulator 130 simulates bank software 240. Bank software 240 may include any software and/or logic that aids user 5 in processing a bank transaction. In the illustrated example, bank software 240 presents a ledger of account information for customer 205. The simulation of bank software 240 within equipment simulator 130 also includes equipment action choices 215. In the example of FIG. 2B, equipment action choices 215 include Withdrawal, Deposit, Consignment, Payments, Misc, Teller, Office, TouchPoint, and Exit.

Teachings of certain embodiments recognize that equipment simulator 130 may be configured to receive inputs from user 5 through defined keystrokes. For example, equipment action choices 215 may be accessed through keystrokes (e.g., ctrl+W for Withdrawals, ctrl+S for straight deposit, PGDN for screen down, Down Arrow for scroll down, F11 for end of customer). Teachings of certain embodiments recognize that equipment simulator 130 may be configured to receive inputs from user 5 through function keys (e.g., F1 through F12). For example, a financial institution's banking software may be configured to receive function keys, and equipment simulator 130 may enable simulated bank software 240 to receive the same function keys.

In some embodiments, user 5 interacts with teller simulator 200 through a web browser window. In some browsers, function keys correspond to certain browser tasks (e.g., pressing F5 instructs the browser to refresh the webpage). However, these same function keys may correspond to certain tasks within bank software 240 (e.g., pressing F5 opens the cash drawer). Accordingly, teachings of certain embodiments recognize the capability for equipment simulator 130 to disable the function keys within the browser so that the function keys may be used within bank software 240. Teachings of certain embodiments also recognize the capability for teller simulator 200 to enable the function keys within the browser whenever customer simulator 120 is engaged. For example, if user 5 is accessing customer simulator 120, then the F5 key may refresh the browser. If user 5 switches to accessing equipment simulator 130, then the F5 key may open the cash drawer.

In some embodiments, equipment simulator 130 may disable a mouse or other pointer device of user 5. In other embodiments, the mouse is enabled and may be used by user 5 in lieu of keyboard strokes. In some embodiments, teller simulator 200 may take points away from user 5 if user 5 chooses to use the mouse instead of the keyboard strokes.

In the illustrated embodiment, user 5 may access customer simulator 120 from equipment simulator 130 by clicking an icon on the left-hand side of the screen. In addition, equipment simulator 130 also provides other equipment choices 220. In this example, equipment simulator 130 presents user 5 with equipment choices 220: validator 222, MICR reader 224, cash drawer 226, counter 228, and supervisor 230.

As explained above, teachings of certain embodiments recognize the capability of customer simulator 120 and equipment simulator 130 to share and exchange information. As one example, customer 205 may present documents within customer simulator 120, and user 5 may validate those documents using validator 222 within equipment simulator 130. As another example, customer 205 may present documents within customer simulator 120, and user 5 may read those documents using MICR reader 224 within equipment simulator 130. As yet another example, customer 205 may request cash within customer simulator 120, and user 5 may access cash drawer 226 within equipment simulator 130 to retrieve the cash. In this example, user 5 may also lay out the cash in an orderly fashion using counter 228 within equipment simulator 130. As yet another example, user 5 may ask to see a supervisor 230 without leaving equipment simulator 130.

FIG. 2C shows an example MICR reader 224 within equipment simulator 130 according to one embodiment. In this example, user 5 may also access customer simulator 120, counter 228, supervisor 230, and bank software 240 from equipment simulator 130.

FIG. 2D shows an example cash drawer 226 and counter 228 within equipment simulator 130 according to one embodiment. User 5 may withdraw cash and present the cash to customer 205 by clicking and dragging cash from cash drawer 226 and counter 228. In this example, user 5 may also select from customer action choices 210 within equipment simulator 130. Thus, teachings of certain embodiments recognize the capability to interact with customer 205 without leaving equipment simulator 230. User 5 may also access customer simulator 120, supervisor 230, and bank software 240 from equipment simulator 130.

FIG. 2E shows a tracking panel 250 according to one embodiment. Tracking panel 250 tracks the tasks completed by user 5 as well as the actual order of actions performed by user 5. In some embodiments, teller simulator 200 does not make tracking panel 250 available to the user 5 who interacted with customer simulator 120 and/or equipment simulator 130. For example, in some embodiments, teller simulator 200 only makes tracking panel 250 available to test administrators. In some embodiments, teller simulator 200 also makes tracking panel 250 available to managers and supervisors.

FIG. 2F shows a teller readiness report 260 according to one embodiment. In this example, teller readiness report 260 displays an overall score 262 and skill scores 264. Overall score 262 provides an overall assessment for user 5. Skill scores 264 assess various facets of teller readiness, such as customer experience, executing transactions, compliance and adherence to guidelines, cash handling, balancing, referrals, fraud prevention, and process order. In FIG. 2F, overall score 262 and skill scores 264 are shown in a bar graph. In this example, the length of each bar signifies whether user 5 is “ready,” will be “ready with practice,” or is “not ready” to serve live customers.

FIG. 2G shows a user assessment report 270 according to one embodiment. In this example, user assessment report 270 provides information on the strengths and weaknesses of user 5. User assessment report 270 organizes the strengths and weaknesses of user 5 into three categories: strengths category 272, meets expectations category 274, and required development category 276. Strengths category 272 identifies the tasks at which user 5 excelled. Meets expectations category 274 identifies the tasks at which user 5 achieved a required level of competency. Required development category 276 identifies the tasks at which user 5 should improve before serving live customers. User assessment report 270 organizes each task within the categories by skill.

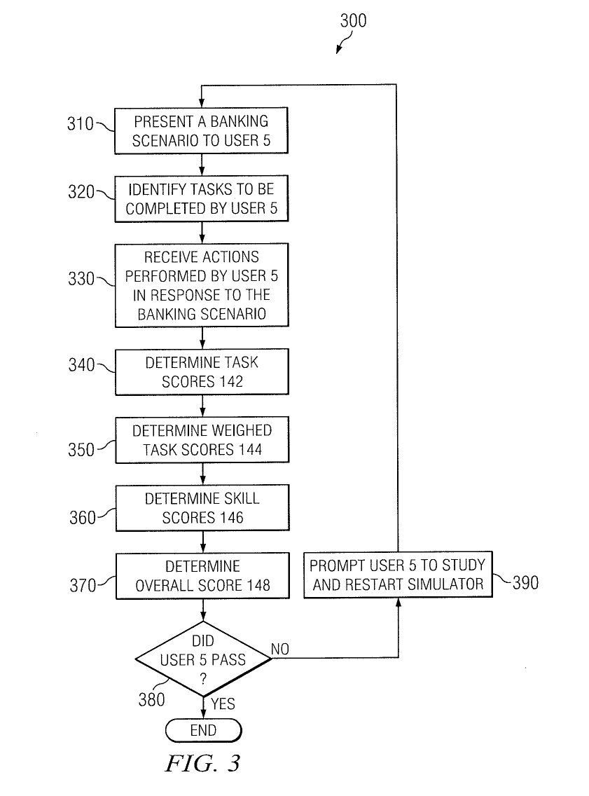

FIG. 3 shows a method 300 for assessing teller readiness according to one embodiment. At step 310, teller simulator 200 presents a banking scenario to user 5. At step 320, teller simulator 200 identifies tasks to be completed by user 5. For example, the banking scenario may include a customer 205 who wishes to make a cash withdrawal, and teller simulator 200 identifies tasks necessary to process the transaction. At step 330, user 5 performs actions in response to the banking scenario, and teller simulator 200 receives and records these actions.

At step 340, teller simulator 200 determines a task score 142 for each task based on the actions performed by user 5. Each task score 142 is associated with one of a plurality of skills. At step 350, teller simulator 200 applies weights to each task score 142 to yield weighed task scores 144. At step 360, teller simulator 200 determines a skill score 146 for each one of the skills based on the weighed task scores 144. At step 370, teller simulator 200 determines the overall score 148 for user 5.

At step 380, teller simulator compares the computed overall score 148 to a predefined threshold to determine whether user 5 passed. For example, in one embodiment, the overall score 148 for user 5 indicates whether user 5 is “ready” or “not ready” to serve live customers. In this example, user 5 may end the simulation if user 5 passes. If user 5 does not pass, however, teller simulator 200 may prompt user 5 to study and restart the simulator at a later time. In some embodiments, teller simulator 200 will also report the results of step 380 to the manager or supervisor of user 5.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

1. A teller readiness system, comprising:
a processor; and
a non-transitory computer-readable storage medium embodying software that is operable when executed by the processor to:
present a banking scenario to a user, the banking scenario simulating a transaction between a bank customer and the user;
identify tasks to be completed by the user;
receive actions performed by the user in response to the scenario;
determine a task score for each task by comparing the tasks to be completed by the user with the actions actually performed by the user, wherein each task is associated with one of a plurality of skills, and each skill of the plurality of skills represents a facet of teller readiness;
assign a weight to each of the task scores to yield weighted task scores;
determine a skill score for one of the skills based on the weighted task scores associated with the one of the skills; and
assign a rating to the one of the skills based on the skill score, wherein the rating is one of a high rating, a medium rating, and a low rating.

2. The teller readiness system of claim 1, wherein the software is further operable to:
record an order of actions performed by the user;
determine the task score for each task according to the order of actions performed by the user; and
determine the skill score by determining a process order skill score based on the weighted task scores corresponding to the task scores based on the order of actions performed by the user, the process order skill score representing a teller's ability to complete tasks in an appropriate order.

3. The teller readiness system of claim 1, wherein:
each task has a maximum score;
each skill has a maximum score;
each task has a maximum weighted score;
the maximum score for each skill is equal to the sum of the maximum weighted scores associated with the skill; and
the weight for each task score is equal to the task's maximum weighted score divided by the task's maximum score.

4. The teller readiness system of claim 1, wherein:
presenting the banking scenario to the user comprises providing a customer simulator and an equipment simulator, the customer simulator simulating an interaction between the banking customer and the user, the equipment simulator simulating an interaction between the user and one or more pieces of banking equipment; and
the tasks to be completed comprise at least one task to be performed using the customer simulator and at least one task to be performed using the equipment simulator.

5. (canceled)

6. The teller readiness system of claim 1, wherein the software is further operable to determine an overall user rating based on one or more of the following criteria: a number of the user's high-rating skills, a number of the user's medium-rating skills, and a number of the user's low-rating skills.

7. The teller readiness system of claim 1, wherein the software is further operable to generate a user assessment report, the user assessment report organizing at least some of the skills and tasks according to the user's strengths and weaknesses.

8. A non-transitory computer readable medium comprising logic for execution, the logic, when executed by a processor, operable to:
present a banking scenario to the user, the banking scenario simulating a transaction between a bank customer and the user;
identify tasks to be completed by the user;
receive actions performed by the user in response to the scenario;
determine a task score for each task by comparing the tasks to be completed by the user with the actions actually performed by the user, wherein:
each task is associated with one of a plurality of skills; and
each skill of the plurality of skills represents a facet of teller readiness;
assign a weight to each of the task scores to yield weighted task scores;
determine a skill score for one of the skills based on the weighted task scores associated with the one of the skills; and
assign a rating to the one of the skills based on the skill score, wherein the rating is one of a high rating, a medium rating, and a low rating.

9. The medium of claim 8, the logic, when executed, being further operable to:
receive an order of actions performed by the user;
determine at least some task scores according to the order of actions performed by the user; and
determine a process order skill score based on the weighted task scores corresponding to the task scores based on the order of actions performed by the user, the process order skill score representing a teller's ability to complete tasks in an appropriate order.

10. The medium of claim 8, wherein:
each task has a maximum score;
each skill has a maximum score;
each task has a maximum weighted score;
the maximum score for each skill is equal to the sum of the maximum weighted scores associated with the skill; and
the weight for each task score is equal to the task's maximum weighted score divided by the task's maximum score.

11. The medium of claim 8, wherein:
the logic when executed is further operable to present the banking scenario to the user by providing a customer simulator and an equipment simulator, the customer simulator simulating an interaction between the banking customer and the user, the equipment simulator simulating an interaction between the user and one or more pieces of banking equipment; and
the tasks to be completed comprise at least one task to be performed using the customer simulator and at least one task to be performed using the equipment simulator.

12. (canceled)

13. The medium of claim 8, the logic when executed is further operable to generate a user assessment report, the user assessment report organizing at least some of the skills and tasks according to the user's strengths and weaknesses.

14. A method of assessing teller readiness, comprising:
presenting, by a processor, a banking scenario to the user, the banking scenario simulating a transaction between a bank customer and the user;
identifying, by the processor, tasks to be completed by the user;
receiving, by the processor, actions performed by the user in response to the scenario;
determining, by the processor, a task score for each task by comparing the tasks to be completed by the user with the actions actually performed by the user, wherein:
each task is associated with one of a plurality of skills; and
each skill of the plurality of skills represents a facet of teller readiness;
assigning, by the processor, a weight to each of the task scores to yield weighted task scores;
determining, by the processor, a skill score for one of the skills based on the weighted task scores associated with the one of the skills; and
assign, by the processor, a rating to the one of the skills based on the skill score, wherein the rating is one of a high rating, a medium rating, and a low rating.

15. The method of claim 14, the method further comprising:
recording, by the processor, an order of actions performed by the user;
determining, by the processor, at least some task scores according to the order of actions performed by the user; and
determining, by the processor, a process order skill score based on the weighted task scores corresponding to the task scores based on the order of actions performed by the user, the process order skill score representing a teller's ability to complete tasks in an appropriate order.

16. The method of claim 14, wherein:
each task has a maximum score;
each skill has a maximum score;
each task has a maximum weighted score;
the maximum score for each skill is equal to the sum of the maximum weighted scores associated with the skill; and
the weight for each task score is equal to the task's maximum weighted score divided by the task's maximum score.

17. The method of claim 14, wherein:
presenting a banking scenario to the user further comprises providing a customer simulator and an equipment simulator, the customer simulator simulating an interaction between the banking customer and the user, the equipment simulator simulating an interaction between the user and one or more pieces of banking equipment; and
the tasks to be completed comprise at least one task to be performed using the customer simulator and at least one task to be performed using the equipment simulator.

18. (canceled)

19. The method of claim 14, further comprising determining, by the processor, an overall user rating based on one or more of the following criteria: a number of the user's high-rating skills, a number of the user's medium-rating skills, and a number of the user's low-rating skills.

20. The method of claim 14, further comprising generating, by the processor, a user assessment report, the user assessment report organizing at least some of the skills and tasks according to the user's strengths and weaknesses.

21. The teller readiness system of claim 1, wherein assigning the rating to the one of the skills based on the skill score comprises comparing the skill score to one or more threshold scores.

22. The teller readiness system of claim 1, wherein assigning the rating to the one of the skills based on the skill score comprises:
assigning the low rating if the skill score is lower than a first threshold score;
assigning the medium rating if the skill score is between the first threshold score and a second threshold score; and
assigning the high rating if the skill score is greater than the second threshold score.

23. The teller readiness system of claim 1, wherein:
the one of the skills is an executing transactions skill; and
the identified tasks associated with the executing transactions skill comprise one or more of:
accurately inputting transaction data;
correctly identifying a type of the transaction;
verifying that transaction documents are complete and accurate;
recognizing whether a check is negotiable and properly endorsed; and
correctly using a magnetic ink character recognition reader.

24. The teller readiness system of claim 1, wherein:
the one of the skills is a compliance skill; and
the identified tasks associated with the compliance skill comprise one or more of:
locking drawers;
placing appropriate transaction holds;
recognizing when the transaction is beyond authority limits; and
following correct customer identification procedure.

25. The teller readiness system of claim 1, wherein:
the one of the skills is a process order skill; and
the identified tasks associated with the process order skill comprise one or more of:
performing all necessary steps;
performing only necessary steps; and
performing steps in a correct order.

26. The teller readiness system of claim 4, wherein the interaction between the banking customer and the user simulated by the customer simulator comprises one or more of:
concluding the transaction and thanking the banking customer;
asking the banking customer to repeat a request;
asking the banking customer to present identification;
asking the banking customer to slide a card; and
requesting additional information from the banking customer to complete a currency transaction report.

27. The teller readiness system of claim 4, wherein the interaction between the user and one or more pieces of banking equipment simulated by the equipment simulator comprises one or more of:
validating documents using a validator;
reading documents using a magnetic ink character recognition reader; and
accessing a cash drawer.

28. The teller readiness system of claim 4, wherein the customer simulator further simulates a customer service indicator, wherein the customer service indicator changes based at least in part on a timer.

29. The teller readiness system of claim 28, wherein the timer resets when the user completes a customer presentation task.
